(19) United States
(12) Patent Application Publication
(10) Pub. No.: US 2012/0110596 A1
(43) Pub. Date: May 3, 2012

(54) Method for Giving Message Prompt When Mobile Terminal Accesses Mobile Internet Website and Mobile Terminal

(75) Inventor: Baozhong Zhou, Guangdong (CN)

(73) Assignee: HUIZHOU TCL MOBILE COMMUNICATION CO.,LTD, Huizhou City, Guangdong (CN)

(21) Appl. No.: 13/381,947

(22) PCT Filed: Dec. 16, 2010
(86) PCT No.: PCT/CN10/79904

§ 371 Date: Dec. 31, 2011

(30) Foreign Application Priority Data
Jun. 22, 2010 (CN) 201010210698.1

(51) Int. Cl. G06F 9/46

(52) U.S. Cl. 719/315

(57) ABSTRACT

A method for giving a message prompt when a mobile terminal accesses a mobile Internet website and the mobile terminal are disclosed in the present disclosure. The method comprises the following steps of: A. receiving a message of browsing a mobile Internet webpage from a user, and triggering a corresponding message prompt event as needed; and B. parsing the message prompt event to obtain a corresponding prompt message, and displaying the prompt message. Because the present disclosure provides a new function of giving a corresponding message prompt when the mobile terminal accesses a mobile Internet website (e.g., prompting the user of the website traffic, the fee charging information, advertisement information, and etc.), the user can timely know conditions of his or her mobile terminal accessing the Internet, which is very convenient for the user.

### FIELD OF THE INVENTION

The present disclosure generally relates to the technical field of communication, and more particularly, to a method for giving a message prompt when a mobile terminal accesses a mobile Internet website and the mobile terminal.

### BACKGROUND OF THE INVENTION

WAP (Wireless Application Protocol) is a global unified open protocol standard for providing Internet content and advanced value-added services to mobile terminals (mobile phones). WAP defines a universal platform that can convert information in the HTML language in the Internet into information described in WML (Wireless Markup Language) for display on a mobile terminal's screen.

The most commonly used mobile phones adopting the WAP technology are WAP mobile phones. By integrating Internet technologies and mobile phone technologies together, the WAP mobile phones allow users to access the Internet through the mobile phones. Thus, a user owning a WAP-enabled mobile phone is able to access the Internet at any time and at any place, including sending or receiving e-mails, accessing webpages on WAP websites and so on.

However, mobile phones currently available lack the function of giving a message prompt when accessing a mobile Internet website. For example, a user may desire to get message prompts involving such as the data amount, fee charging information, advertisement information or the like when accessing a WAP website, but none of the conventional mobile phones can achieve this function.

Accordingly, improvements and advancements still have to be made in the art.

### SUMMARY OF THE INVENTION

An objective of the present disclosure is to overcome the aforesaid shortcomings of the prior art by providing a method for giving a message prompt when a mobile terminal accesses a mobile Internet website and the mobile terminal. The method for giving a message prompt when a mobile terminal accesses a mobile Internet website and the mobile terminal of the present disclosure provide a new function of giving a message prompt when the mobile terminal accesses a mobile Internet website, and this makes the mobile phone very convenient to use.

The technical solutions of the present disclosure are as follows.

The present disclosure provides a method for giving a message prompt when a mobile terminal accesses a mobile Internet website, comprising the following steps of:

A. receiving a message of browsing a mobile Internet webpage from a user, and triggering a corresponding message prompt event as needed; and

B. parsing the message prompt event to obtain a corresponding prompt message, and displaying the prompt message.

Preferably, the method for giving a message prompt when a mobile terminal accesses a mobile Internet website further comprises the following steps prior to the step A:

A1. defining a filename having a specific extension name for each mobile Internet webpage message prompt event; and

A2. encoding the filename having the specific extension name to obtain an encoded filename having the specific extension name.

Preferably in the method for giving a message prompt when a mobile terminal accesses a mobile Internet website, the step B further comprises:

B1. invoking a message prompt module to decode the encoded filename having the specific extension name corresponding to the message prompt event to obtain a decoded filename having the specific extension name;

B2. parsing the decoded filename having the specific extension name to obtain a corresponding prompt message; and

B3. invoking a message prompt box to display the prompt message.

Preferably in the method for giving a message prompt when a mobile terminal accesses a mobile Internet website, the step B3 further comprises: B31. displaying the prompt message continuously for a certain time.

Preferably, the method for giving a message prompt when a mobile terminal accesses a mobile Internet website further comprises the following step subsequent to the step B31:

C. closing the prompt message after the prompt message has been displayed for the certain time, and executing subsequent operations.

Preferably in the method for giving a message prompt when a mobile terminal accesses a mobile Internet website, the filename having the specific extension name comprises: a label indicating whether to give a prompt, a prompt duration, and a prompt content.

The present disclosure further provides a mobile terminal, comprising:

a message prompt event triggering module, being configured to receive a message of browsing a mobile Internet webpage from a user, and triggering a corresponding message prompt event as needed; and

a message prompt module, being configured to parse the message prompt event to obtain a corresponding prompt message and configured to display the prompt message.

Preferably, the mobile terminal further comprises:

a message prompt event defining module, being configured to define a filename having a specific extension name for each mobile Internet webpage message prompt event; and

an encoding module, being configured to encode the filename having the specific extension name to obtain an encoded filename having the specific extension name.

Preferably in the mobile terminal, the message prompt module further comprises:

a decoding unit, being configured to decode the encoded filename having the specific extension name corresponding to the message prompt event to obtain a decoded filename having the specific extension name;

a parsing unit, being configured to parse the decoded filename having the specific extension name to obtain a corresponding prompt message; and

a displaying unit, being configured to invoke a message prompt box to display the prompt message continuously for a time duration.

Preferably in the mobile terminal, the filename having the specific extension name comprises: a label indicating whether to give a prompt, a prompt duration, and a prompt content.

Because the method for giving a message prompt when a mobile terminal accesses a mobile Internet website and the mobile terminal according to the present disclosure have a new function of giving a corresponding message prompt when the mobile terminal accesses a mobile Internet website (e.g., prompting the user of the website traffic, the fee charging information, advertisement information, and etc.), the user can timely know conditions of his or her mobile terminal accessing the Internet, which is very convenient for the user.

### BRIEF DESCRIPTION OF THE DRAWINGS

In order to more clearly describe the technical solutions of the embodiments of the present disclosure, attached drawings to be used in the detailed description of the disclosure will be briefly described hereinbelow. Obviously, the attached drawings described hereinbelow only illustrate some of the embodiments of the present disclosure, and those of ordinary skill in the art can also obtain other attached drawings therefrom without the need of making inventive efforts, wherein:

FIG. 1 is a flowchart diagram of a method for giving a message prompt when a mobile terminal accesses a mobile Internet website according to an embodiment of the present disclosure;

FIG. 2 is a further flowchart diagram of the method for giving a message prompt when a mobile terminal accesses a mobile Internet website according to an embodiment of the present disclosure;

FIG. 3 is a block diagram of a mobile terminal according to an embodiment of the present disclosure; and

FIG. 4 is a block diagram of a message prompt module in the mobile terminal according to an embodiment of the present disclosure.

### DETAILED DESCRIPTION OF THE INVENTION

The present invention is further described in detail below with reference to the accompanying drawings and embodiments.

The present disclosure provides a method for giving a message prompt when a mobile terminal accesses a mobile Internet website and the mobile terminal. In order to make objectives, technical solutions and advantages of the present disclosure more apparent and obvious, embodiments of the present disclosure will be further detailed hereinbelow with reference to the attached drawings. However, it shall be appreciated that, the embodiments described herein are only intended to illustrate but not to limit the present disclosure.

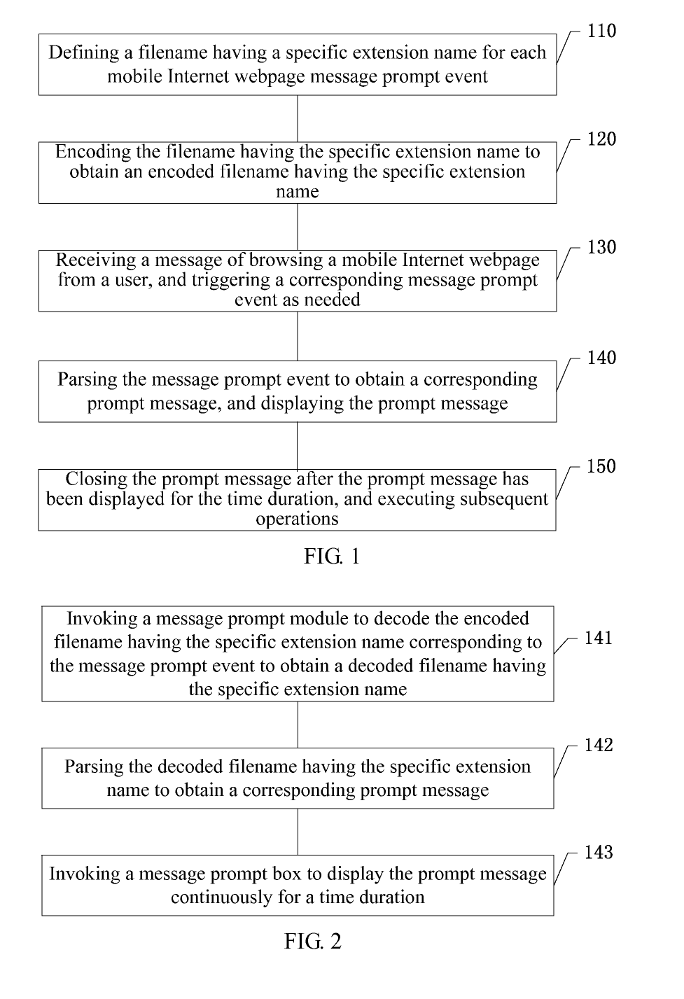

As shown in FIG. 1, the present disclosure provides a method for giving a message prompt when a mobile terminal accesses a mobile Internet website, which mainly comprises the following steps.

Step 110: defining a filename having a specific extension name for each mobile Internet webpage message prompt event.

Because the WML language is used for existing WAP websites, no message prompt label is available. In order to accomplish a specific service on a WAP webpage through use of a message prompt module of a mobile phone, a file type or a specific filename having a specific extension name is defined firstly in this embodiment of the present disclosure. An extension name “.pom” is defined for a file, a filename of the file having the specific extension name corresponds to a mobile Internet webpage, and a suffix “.pom” is appended to the WAP webpage filename.

The filename having the specific extension name includes three elements: a label indicating whether to give a prompt, a prompt duration, and a prompt content. A separator “|” may be used between any two of these elements, and the content of the prompt is followed by the suffix “.pom”.

In the present disclosure, a prompt format of the three elements of the filename having a specific extension name, may be predetermined as, for example, “the label indicating whether to give a prompt|the prompt content|the prompt duration”, “the prompt content|the label indicating whether to give a prompt| the prompt duration”, “the prompt content|the prompt duration|the label indicating whether to give a prompt” or “the prompt duration| the prompt content|the label indicating whether to give a prompt” and so on.

For example, in a case where it is necessary to provide a prompt of data traffic to the user, a specific data traffic event indicates “3-seconds of prompting “data traffic of 200K””. Then, among the three elements of the specific data traffic event, the label indicating whether to give a prompt is Yes, the prompt duration is 3 seconds, and the prompt content is “data traffic of 200K”. This specific data traffic event triggers a corresponding message prompt event for display, and a filename having a specific extension name corresponding to the data traffic message prompting event shall be “1|3|data traffic of 200K.pom”.

Step 120: encoding the filename having the specific extension name to obtain an encoded filename having the specific extension name.

As described above, the filename having an extension name shall be “1|3|data traffic of 200K.pom”. After being encoded, the filename is represented by hexadecimal UNICODE codes, so an encoded filename “????????????????.pom” having a specific extension name is obtained. Here, “.pom” is the specific extension name.

Step 130: receiving a message of browsing a mobile Internet webpage from a user, and triggering a corresponding message prompt event as needed.

When the user browses a webpage on the WAP website through his or her mobile phone, a message prompt event is triggered. For example, if it is necessary to prompt the user of the data traffic of a new webpage when the user logs on the webpage, then a traffic prompt event is triggered. The traffic prompt event corresponds to the encoded filename having the specific extension name, e.g., the UNICODE encoded filename “????????????????.pom” described above.

Step 140: parsing the message prompt event to obtain a corresponding prompt message, and displaying the prompt message.

As shown in FIG. 2, the step 140 further comprises the following steps.

Step 141: invoking a message prompt module to decode the encoded filename having the specific extension name corresponding to the message prompt event to obtain a decoded filename having the specific extension name.

If the system finds that the encoded filename having the specific extension name comprises the specific extension name (e.g., the suffix “p.com”), then the message prompt module is invoked to decode the filename to obtain a decoded filename having the specific extension name of “1|3|data traffic of 200K.pom”.

Step 142: parsing the decoded filename having the specific extension name to obtain a corresponding prompt message.

That is, the filename having the specific extension name is parsed to obtain a corresponding prompt message: the label indicating whether to give a prompt: Yes; the prompt duration: 3 seconds; and the prompt content: “data traffic of 200K”.

Step 143: invoking a message prompt box to display the prompt message continuously for a certain time.

As described in the above example, the prompt message is displayed to the user by the message prompt box to indicate a data traffic of 200K and a prompt duration of 3 seconds.

Step 150: closing the prompt message after the prompt message has been displayed for the certain time, and executing subsequent operations. That is, after the prompt message has been displayed for the prompt duration, the prompt is ended to execute subsequent procedures.

The above embodiment of the present disclosure is illustrated with a case of prompting the user of the data traffic as an example. However, in practical applications of the present disclosure, website accessing prompts related to other services may also be given, for example, to prompt the user of the fee charging information, to display advertisement information to the user and so on.

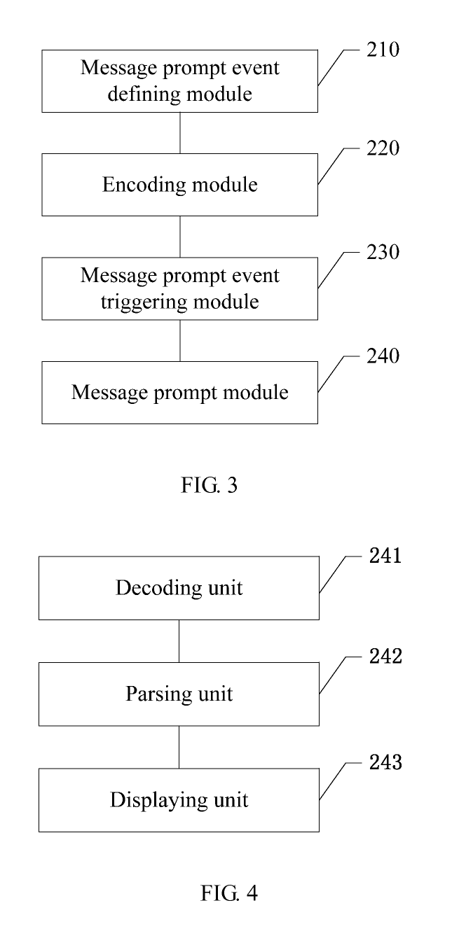

On the basis of the method for giving a message prompt when a mobile terminal accesses a mobile Internet website described above, an embodiment of the present disclosure further provides a mobile terminal. As shown in FIG. 3, the mobile terminal comprises:

a message prompt event defining module 210, being configured to define a filename having a specific extension name for each mobile Internet webpage message prompt event, wherein the filename having the specific extension name comprises: a label indicating whether to give a prompt, a prompt duration, and a prompt content;

an encoding module 220, being configured to encode the filename having the specific extension name to obtain an encoded filename having the specific extension name;

a message prompt event triggering module 230, being configured to receive a message of browsing a mobile Internet webpage from a user, and triggering a corresponding message prompt event as needed;

a message prompt module 240, being configured to parse the message prompt event to obtain a corresponding prompt message and configured to display the prompt message.

As shown in FIG. 4, the message prompt module 240 further comprises:

a decoding unit 241, being configured to decode the encoded filename having the specific extension name corresponding to the message prompt event to obtain a decoded filename having the specific extension name;

a parsing unit 242, being configured to parse the decoded filename having the specific extension name to obtain a corresponding prompt message; and

a displaying unit 243, being configured to invoke a message prompt box to display the prompt message continuously for a certain time.

According to the above descriptions, because the method for giving a message prompt when a mobile terminal accesses a mobile Internet website and the mobile terminal according to the present disclosure have a new function of giving a corresponding message prompt when the mobile terminal accesses a mobile Internet website (e.g., prompting the user of the website traffic, the fee charging information, advertisement information, and etc.), the user can timely know conditions of his or her mobile terminal accessing the Internet, which is very convenient for the user.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims and their equivalents.

What is claimed is:

1. A method for giving a message prompt when a mobile terminal accesses a mobile Internet website, comprising the following steps of:
A. receiving a message of browsing a mobile Internet webpage from a user, and triggering a corresponding message prompt event as needed; and
B. parsing the message prompt event to obtain a corresponding prompt message, and displaying the prompt message.

2. The method for giving a message prompt when a mobile terminal accesses a mobile Internet website of claim 1, further comprising the following steps prior to the step A:
A1. defining a filename having a specific extension name for each mobile Internet webpage message prompt event; and
A2. encoding the filename having the specific extension name to obtain an encoded filename having the specific extension name.

3. The method for giving a message prompt when a mobile terminal accesses a mobile Internet website of claim 2, wherein the step B further comprises:
B1. invoking a message prompt module to decode the encoded filename having the specific extension name corresponding to the message prompt event to obtain a decoded filename having the specific extension name;
B2. parsing the decoded filename having the specific extension name to obtain a corresponding prompt message; and
B3. invoking a message prompt box to display the prompt message.

4. The method for giving a message prompt when a mobile terminal accesses a mobile Internet website of claim 3, wherein the step B3 further comprises: B31. displaying the prompt message continuously for a certain time.
